(19) United States
(12) Patent Application Publication
(10) Pub. No.: US 2006/0005009 A1
(43) Pub. Date: Jan. 5, 2006

(54) Method, system and program product for verifying an attribute of a computing device

(75) Inventors: Charles D. Ball, Raleigh, NC (US); Ryan C. Catherman, Raleigh, NC (US); James P. Hoff, Raleigh, NC (US); James P. Ward, Apex, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/881,870

(22) Filed: Jun. 30, 2004

(51) Int. Cl. H04L 9/00

(52) U.S. Cl. 713/155

(57) ABSTRACT

A solution for verifying an attribute of a computing device. In particular, a computing device can obtain an attribute from another computing device. The attribute can be measure by, for example, a Trusted Platform Module integrated on the other computing device. The computing device can then use an attestation server to determine whether the attribute reflects a desirable value or indicates that the other computing device may have been compromised.

### BACKGROUND OF THE INVENTION

1. Technical Field

The invention relates generally to verifying an attribute of a computing device, and more particularly to verifying an attribute provided by the computing device which indicates that the computing device is a trusted device.

2. Background Art

As business transactions and sensitive information are increasingly communicated over public computer networks such as the Internet, security concerns have also increased. As a result, these communications are frequently encrypted using a security protocol such as secure sockets layer (SSL) or the like to help ensure that the information is not intercepted during transmission. Further, many security protocols incorporate public/private keys that can be used to authenticate the identity of the computing device that is sending/receiving the encrypted information.

However, these security solutions remain insufficient for some applications. In particular, it may be desired to obtain some assurance that the computing device, such as a personal computer, mobile telephone, personal digital assistant (PDA), etc., has not been corrupted with a virus, accessed by an unauthorized user, or the like, i.e., that the computing device is a “trusted computer system.” For example, a computing device may seek to obtain information on one or more attributes of another computing device such as its hardware configuration, firmware, operating system, services, applications, integrity metrics, etc. Using this information, the computing device can then make an informed decision as to whether the other computing device can be trusted.

As a result, a group of manufacturers have formed the Trusted Computing Group (TCG), which is seeking to define a specification that will enable a computing device to provide attribute information in a secure manner to another computing device. The specification, as currently defined, is described in detail in a document entitled “TCG Specification Architecture Overview,” Rev. 1.2, 28 Apr. 2004, which is hereby incorporated herein by reference. In general, the specification calls for a computing device to be built with an integrated Trusted Platform Module (TPM). The TPM comprises a passive device that is installed in a computing device, and which can accurately measure, securely store, and securely communicate information on one or more attributes of the computing device. To this extent, the TPM can create an Attestation Identity Key (AIK) that is used to encrypt the attribute information and authenticate identification when the attribute information is communicated to another computing device. In this manner, the receiving computing device can be assured of the sender's identity as well as the accuracy of the attribute information that was communicated.

Once a computing device is confident that it has received accurate attribute information, it still may be necessary to determine the relevance of the attribute information, e.g., whether the attribute information makes the other computing device a “trusted computer system.” In particular, the computing device may need to verify the attribute information with an appropriate certification authority (CA). However, there are potentially millions of attributes and thousands of CAs for various computing device attributes. As a result, it is not desirable to require that each computing device interact with each CA and/or store valid values for each attribute that may require verification.

To date, there is no infrastructure protocol for addressing the interaction between a computing device and an appropriate CA for verifying attribute information. In particular, an infrastructure protocol is required that enables a computing device that has received attribute information from another computing device to determine from a vendor, CA, or the like, whether the attribute information makes the other computing device a trusted computer system.

As a result, a need exists for a solution for verifying an attribute of a computing device. In particular, a need exists for a method, system and program product that verify whether a quoted value for the attribute is a valid value using an attestation server.

### SUMMARY OF THE INVENTION

The invention provides a method, system and program product for verifying an attribute of a computing device. Specifically, under the present invention, a quoted value that defines the attribute can be obtained by another computing device and verified using an attestation server. The attestation server can store a set of validation entries that each include a valid value that has been verified by a certification authority for a corresponding attribute. Various configurations are possible for communications between the computing device, attestation server, and/or certification authority that propagate new valid values and/or compare a quoted value with known valid values.

A first aspect of the invention provides a method of verifying an attribute of a computing device, the method comprising: receiving a quoted value that defines the attribute from the computing device; obtaining a valid value from an attestation server, wherein the valid value has been verified by a certification authority; and comparing the quoted value to the valid value.

A second aspect of the invention provides a method of verifying an attribute of a first computing device, the method comprising: obtaining a valid value that has been verified by a certification authority; receiving a quoted value that defines the attribute from a second computing device; and comparing the quoted value to the valid value.

A third aspect of the invention provides a system for verifying an attribute of a computing device, the system comprising: an attestation server for storing a set of valid values, wherein each valid value has been certified by a certification authority; an assurance system for receiving an attestation identity key (AIK) and a quoted value from the computing device and verifying the quoted value using the AIK; and a validation system for validating the quoted value using the attestation server.

A fourth aspect of the invention provides a program product stored on a recordable medium for verifying an attribute of a computing device, which when executed comprises: program code for receiving a quoted value that defines the attribute from the computing device; program code for obtaining a valid value from an attestation server, wherein the valid value has been verified by a certification authority; and program code for comparing the quoted value to the valid value.

A fifth aspect of the invention provides a system for deploying an application for verifying an attribute of a first computing device, the system comprising a computer infrastructure being operable to: obtain a valid value that has been verified by a certification authority; receive a quoted value that defines the attribute from a second computing device; compare the quoted value to the valid value; and provide a result of the comparison to the second computing device.

A sixth aspect of the invention provides computer software embodied in a propagated signal for verifying an attribute of a computing device, the computer software comprising instructions to cause a computer system to perform the following functions: receive an attestation identity key (AIK) and a quoted value from the computing device; verify the quoted value using the AIK; and validate the quoted value using an attestation server that comprises a set of valid values, wherein each valid value has been certified by a certification authority.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for verifying an attribute of a computing device;

FIG. 2 shows an illustrative data flow diagram for the system shown in FIG. 1 according to one embodiment of the invention;

FIG. 3 shows an illustrative data flow diagram for the system shown in FIG. 1 according to another embodiment of the invention; and

FIG. 4 shows an illustrative data flow diagram for the system shown in FIG. 1 according to still another embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a method, system and program product for verifying an attribute of a computing device. Specifically, under the present invention, a quoted value that defines the attribute can be obtained by another computing device and verified using an attestation server. The attestation server can store a set of validation entries that each include a valid value that has been verified by a certification authority for a corresponding attribute. Various configurations are possible for communications between the computing device, attestation server, and/or certification authority that propagate new valid values and/or compare a quoted value with known valid values.

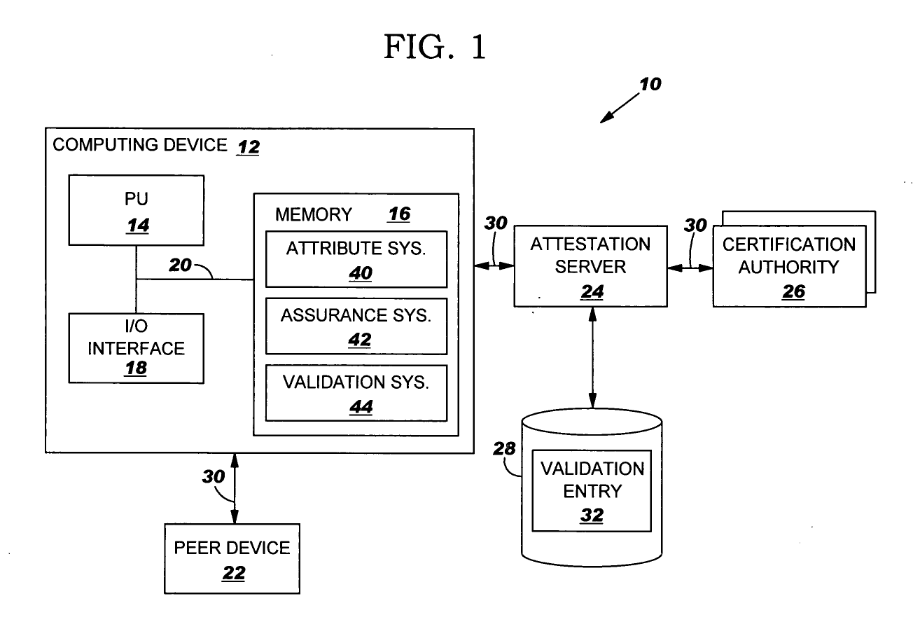

Turning to the drawings, FIG. 1 shows an illustrative system 10 for verifying an attribute of a computing device, e.g., peer device 22. In particular, computing device 12 can obtain an attribute from peer device 22. Computing device 12 can use attestation server 24 to determine the relevance of the attribute. Attestation server 24 can communicate with a certification authority 26 to obtain valid value(s) for the attribute, and attestation server 24 can store the valid values in a set (one or more) of validation entries 32. The set of validation entries 32 can be used to verify the attribute of peer device 22.

As shown, communications between computing device 12, peer device 22, attestation server 24, and/or certification authority 26 can occur over one or more networks 30. To this extent, each network 30 can comprise any type of communications link. For example, network 30 can comprise an addressable connection in a client-server (or server-server) environment that may utilize any combination of wireline and/or wireless transmission methods. In this instance, computing device 12, peer device 22, attestation server 24, and/or certification authority 26 may utilize conventional network connectivity, such as Token Ring, Ethernet, WiFi or other conventional communications standards. Further, network 30 can comprise any type of network, including the Internet, a wide area network (WAN), a local area network (LAN), a virtual private network (VPN), etc. Where network 30 comprises the Internet, connectivity could be provided by conventional TCP/IP sockets-based protocol, and a computer system, e.g., computing device 12 could utilize an Internet service provider to establish connectivity.

As shown, computing device 12 generally includes a processing unit (PU) 14, a memory 16, an input/output (I/O) interface 18, and a bus 20. As is known in the art, PU 14 uses bus 20 to access computer program code stored in memory 16 and process and/or generate data that is stored in memory 16 and/or input/output using I/O interface 18. To this extent, PU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. I/O interface 18 may comprise any system for exchanging information to/from one or more other computing devices (e.g., peer device 22) and/or one or more users (not shown). Bus 20 provides a communication link between each of the components in computing device 12 and likewise may comprise any known type of transmission link, including electrical, optical, wireless, etc. In addition, although not shown, additional components, such as system software, may be incorporated into computing device 12 as are known in the art.

Further, attestation server 24 is also shown in communication with a storage unit 28, which may comprise any type of data storage for providing storage for information, e.g., set of validation entries 32, necessary to carry out the invention as described herein. As such, storage unit 28 may include one or more storage devices, such as a magnetic disk drive or an optical disk drive. Moreover, similar to PU 14, memory 16 and/or storage unit 28 may reside at a single physical location, comprising one or more types of data storage, or be distributed across a plurality of physical systems in various forms. Further, memory 16 and/or storage unit 28 can include data distributed across, for example, a LAN, WAN or a storage area network (SAN) (not shown).

It is understood that computing device 12 comprises any type of computer system capable of communicating with one or more other computing devices (e.g., attestation server 24). Similarly, peer device 22, attestation server 24, and certification authority 26 each can comprise any type of computer system, such as a server, a desktop computer, a laptop, a handheld device, a mobile phone, a pager, a personal data assistant, etc. To this extent, peer device 22, attestation server 24, and certification authority 26 typically include the sane elements as shown in computing device 12 (e.g., PU, memory, I/O interface, etc.). These have not been separately shown and discussed for brevity.

Computing device 12 is shown including various systems stored in memory 16 as computer program code. In general, attribute system 40 can obtain and communicate one or more attributes of computing device 12 to another computing device, e.g., peer device 22. To this extent, it is understood that all or a portion of attribute system 40 could be implemented as hardware such as a Trusted Platform Module (TPM) as described above. Assurance system 42 can communicate with another computing device, such as peer device 22, and obtain one or more attributes therefrom. Validation system 44 can verify a received attribute using attestation server 24. It is understood that some of the various systems shown in FIG. 1 can be implemented independently, combined, and/or stored in memory for one or more separate computing devices 12 that communicate over a network. Further, it is understood that some of the systems and/or functionality may not be implemented, or additional systems and/or functionality may be included as part of system 10.

In general, computing device 12 obtains an attribute from peer device 22 and verifies the attribute using attestation server 24. As used herein, an “attribute” can comprise any aspect of peer device 22 that another computing device (e.g., computing device 12) may desire to know. To this extent, the attribute may reflect the operational state of peer device 22, and could comprise any software configuration, hardware configuration, event, and/or any combination thereof. For example, the attribute could comprise a particular type and/or version of a basic input output system (BIOS), an operating system, application, or the like. Further, the attribute could comprise security measures in place for peer device 22, processor and/or memory configuration, etc. Still further, the attribute could comprise events such as a login/logout, a failed login, a virus detection, etc.

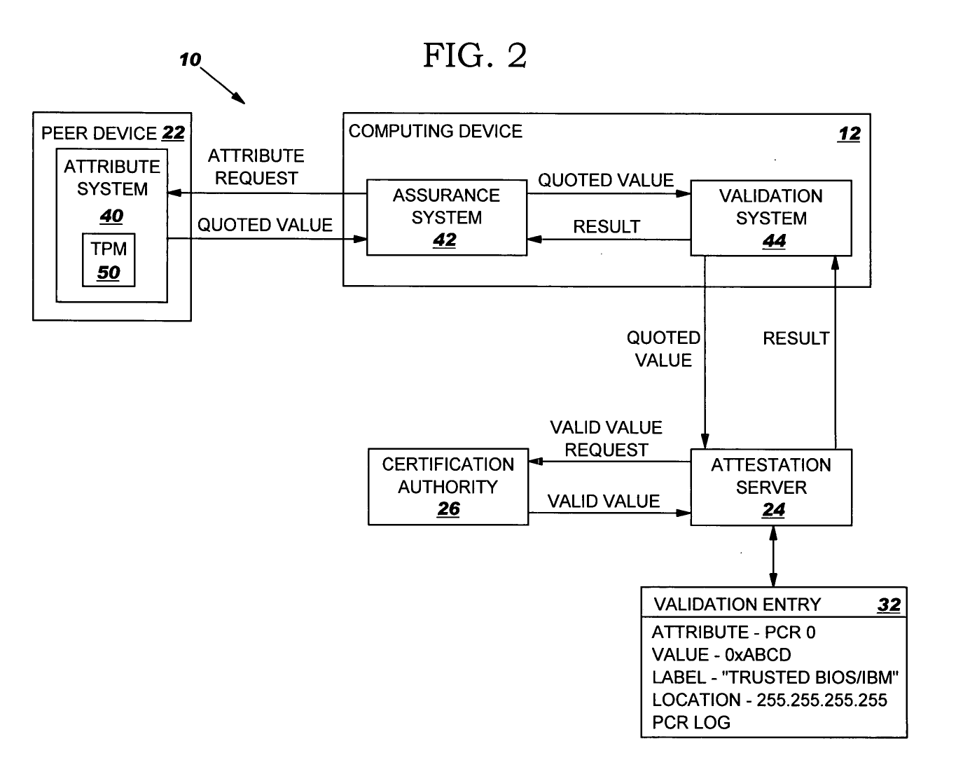

In any event, an application (not shown) on computing device 12 may desire to perform a transaction with peer device 22 (e.g., electronic funds transfer). In this case, the application may desire to obtain some assurance that peer device 22 can be trusted. As a result, the application can initiate assurance system 42 to determine if peer device 22 can be trusted. FIG. 2 shows an illustrative data flow diagram for system 10 according to one embodiment of the invention. Initially, as shown, assurance system 42 on computing device 12 can generate an attribute request that is communicated to peer device 22. Peer device 22 also can comprise an attribute system 40 that processes the attribute request and returns a quoted value that defines the requested attribute to assurance system 42 of computing device 12.

In one embodiment, attribute system 40 comprises a TPM 50. As discussed above, TPM 50 can accurately determine and communicate a quoted value that defines a desired attribute. For example, TPM 50 can measure various measurement events for peer system 22 and store a sequence of related measurement values in one or more Platform Configuration Registers (PCRs). One or more PCR values can be requested and communicated as the quoted value to assurance system 42. To ensure that the quoted value is not corrupted during communication, TPM 50 also can generate an attestation identity key (AIK) that is used to encrypt some or all of the quoted value. Attribute system 40 can communicate the encrypted quoted value and AIK to assurance system 42.

After receiving the quoted value and AIK from attribute system 40 (peer device 22), assurance system 42 can verify an accuracy of the quoted value using the AIK. In particular, as is known in the art, assurance system 42 can decrypt the quoted value using the AIK. Further, attribute system 40 at peer device 22 can provide credentials to assurance system 42 that vouch for the accuracy of the quoted value, e.g., the validity of TPM 50. Assurance system 42 can then verify the credentials, AIK, etc., to ensure that the quoted value comprises an accurate measurement of the requested attribute of peer device 22.

Once assurance system 42 trusts the accuracy of the quoted value, computing device 12 must determine if the quoted value means that peer device 22 can be trusted. In other words, computing device 12 must determine if the quoted value comprises a desirable value (e.g., proper operating system type/version), or if the quoted value indicates that peer device 22 may have been compromised by a virus, unauthorized user, or the like. This may comprise a formidable task due to potentially millions of valid measurements. As a result, validation system 44 can validate the quoted value using attestation server 24.

Attestation server 24 can manage a set of validation entries 32. Each validation entry 32 can comprise, for example, a valid value, a label, and/or a location of a source certification authority 26. In general, the valid value has been generated/verified by certification authority 26, which represents that the valid value comprises a known valid measurement of a particular attribute. The label within validation entry 32 can comprise a text string that describes the valid value, e.g., the attribute measured, identification of certification authority 26, etc., and the location can comprise a network address that enables communication with certification authority 26, if desired. It is understood that validation entry 32 is only illustrative, and numerous configurations for validation entry 32 that may contain more/less information in varying formats are possible.

In any event, validation system 44 validates the quoted value using attestation server 24. In one embodiment, validation system 44 can provide the quoted value to attestation server 24, and receive a result that indicates whether the quoted value comprises a valid value. In this case, attestation server 24 can compare the quoted value with the set of validation entries 32 to determine if one or more of the valid values for the corresponding attribute matches the quoted value. If so, attestation server 24 can return a result indicating that the quoted value comprises a valid value. Further, the result could comprise some or all of the validation entry 32 that was used to verify the quoted value, e.g., the location of certification authority 26.

However, when the quoted value does not match any validation entry 32, attestation server 24 can return a result indicating that the quoted value could not be validated. In this case, validation system 44 can provide the quoted value to another attestation server 24 and/or certification authority 26 to attempt to validate the quoted value. Should validation fail for each attestation server 24 and/or certification authority 26, validation system 44 can return a result to assurance system 42 indicating that the quoted value could not be validated. In this case, assurance system 42 could attempt to validate another attribute of peer device 22, indicate to a calling application that the attribute could not be verified, etc. The application can then determine whether to trust peer device 22.

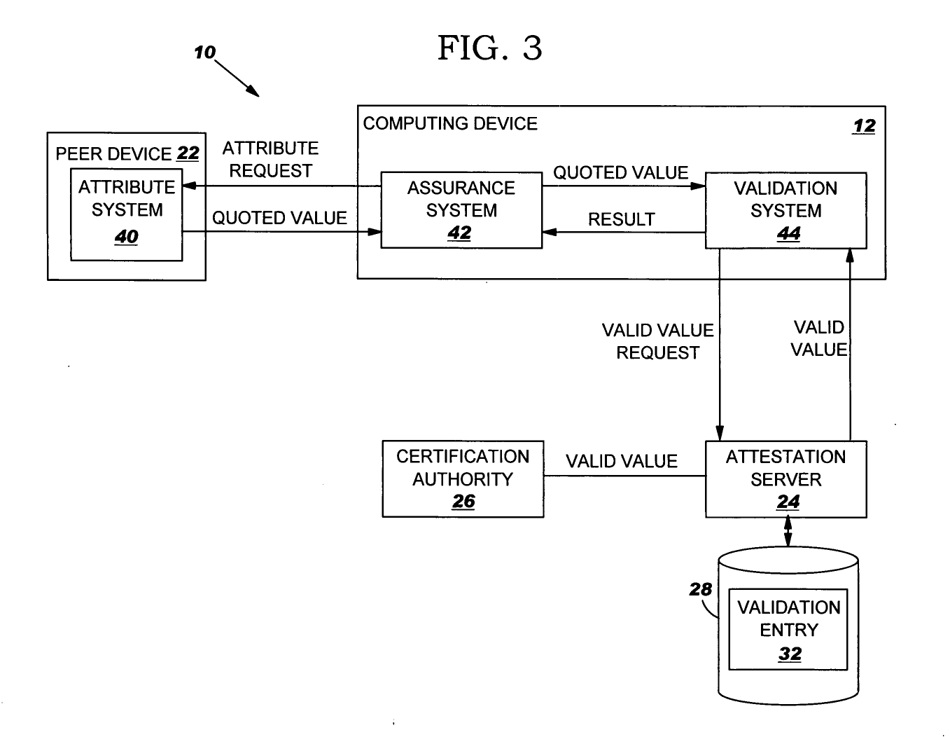

Various alternatives for validating a quoted value using attestation server 24 are possible. For example, FIG. 3 shows an alternative data flow diagram for system 10 in which validation system 44 sends a valid value request to attestation server 24 and receives one or more valid values based on the request. For example, validation system 44 can receive a quoted value for the attribute “PCR 0” from assurance system 42. In this case, validation system 44 can request valid value(s) from attestation server 24 for the attribute “PCR 0.” Attestation server 24 can obtain all validation entries 32 corresponding to “PCR 0” and provide the valid values and/or validation entries 32 to validation system 44. Validation system 44 can then compare the quoted value to the set of valid values received from attestation server 24 and return a result to assurance system 42.

Validation system 44 can store valid values received from attestation server 24 at computing device 12. In one embodiment, validation system 44 can receive validation entries 32 from attestation server 24 and store them locally. In any event, when a quoted value is received from assurance system 42, validation system 44 can first determine if a corresponding valid value is stored at computing device 12 before querying attestation server 24 for any valid values. Attestation server 24 can provide a set of valid values to validation system 44 in response to a request from validation system 44 or periodically. For example, attestation server 24 may receive a new valid value for a particular attribute from certification authority 26 and automatically forward it to validation system 44.

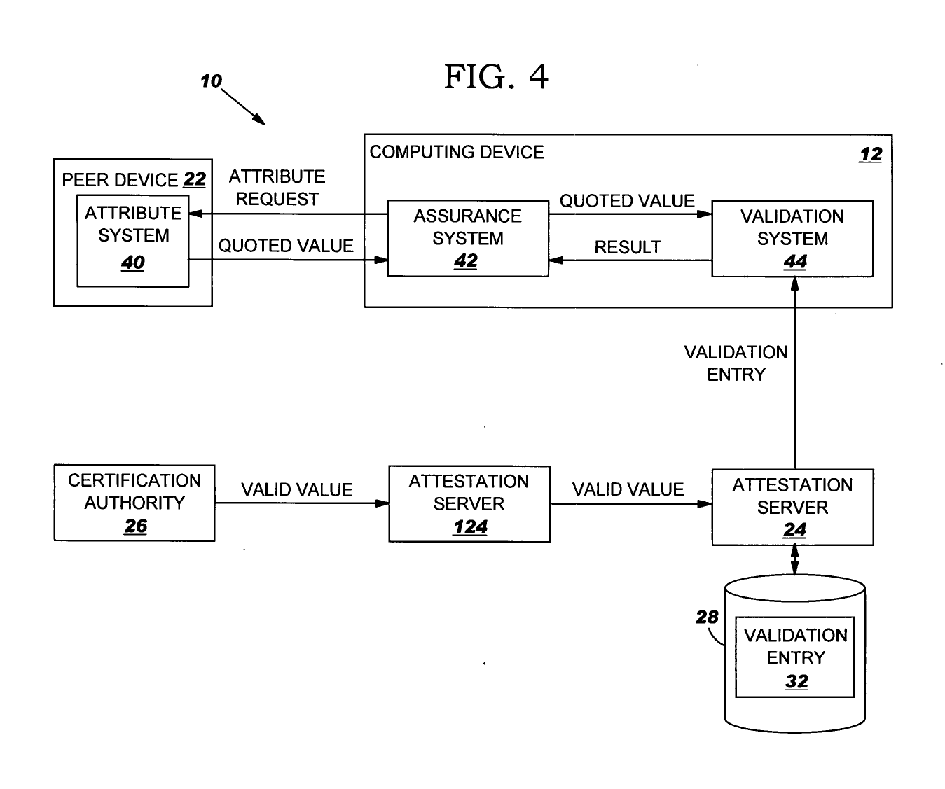

Further, validation system 44 may periodically (e.g., once a day) request valid values for the particular attribute in order to maintain a relatively current local set of valid values. In response, attestation server 24 can provide the set of valid values (or validation entries 32) for the attribute to validation system 44. Alternatively, as shown in FIG. 4, attestation server 24 can periodically “push” newly created validation entries 32 to validation system 44 without having received any request from validation system 44. In this case, all validation entries 32 can be provided to validation system 44, or a subset of validation entries 32 that correspond to a particular attribute can be provided to validation system 44.

As noted previously, attestation server 24 maintains a set of validation entries 32 that each comprise a valid value that has been verified by certification authority 26. Several solutions for updating set of validation entries 32 with new and/or revised valid values are possible. For example, as shown in FIG. 2, attestation server 24 could send a valid value request to certification authority 26 in response to a quoted value received from validation system 44 that has no corresponding validation entry 32. In response, attestation server 24 can receive one or more valid values from certification authority 26. A validation entry 32 for each received valid value can then be generated and stored in storage unit 28 (FIG. 1).

Alternatively, as shown in FIG. 3, certification authority 26 can periodically send one or more new valid values to attestation server 24. For example, certification authority 26 could comprise a software vendor that has released a new version of a software product. As a result of the release, additional valid values for the software product are generated by certification authority 26. In this case, certification authority 26 can propagate the new valid values to one or more attestation servers 24 for use when verifying attributes of peer devices 22.

Still further, as shown in FIG. 4, new valid values can be propagated using a scalable architecture. For example, an architecture similar to the domain name system (DNS) can be used to propagate new valid values/validation entries 32. In this case, a certification authority 26 can propagate a new valid value to a few attestation servers 124 that subsequently propagate the new valid value to other attestation servers 24. In one embodiment, attestation servers 24 propagate new valid values in a hierarchical fashion. In any event, the new valid values can be pushed to the attestation servers 24, as shown in FIG. 4, or provided in response to a request from an attestation server 24 as shown in FIG. 3. In either case, new valid values can be efficiently and scaleably propagated to attestation servers 24 for use in verifying attributes.

As noted previously, it is important that computing device 12 receive a quoted value from peer device 22 that comprises an accurate measurement of the attribute. Similarly, computing device 12 must also receive accurate valid values from attestation server 24, and attestation server 24 must receive accurate valid values from certification authority 26 and/or another attestation server 124 (FIG. 4). To this extent, communications between the various computer systems of system 10 can be encrypted using, for example, the public key infrastructure (PKI) or the like.

Returning to FIG. 2, as discussed above, one embodiment of the invention uses quoted values that comprise one or more PCR values. As is known, TPM 50 can update each PCR value by combining (e.g., hashing) a newly extended value with a previous PCR value. Each extended value is related to an event that occured on peer device 22. As a result, using a PCR value, it can be confirmed that a series of events has occured in a desired order on peer device 22. However, one or more additional events may occur on peer device 22, thereby altering the PCR value. As a result, the actual PCR value may not reflect the valid value stored in validation entry 32, even though all the specified events have occured.

To address this situation, the quoted value can further comprise a peer PCR log for each PCR value. The peer PCR log can comprise a series of extended values (and therefore events) that were used to generate the PCR value. When determining whether the PCR value comprises a valid value, the peer PCR log can be used to confirm that each relevant extended value (event) was logged in a proper sequence by TPM 50. In particular, when the PCR value does not match the valid value, the peer PCR log can be compared to a valid PCR log stored in validation entry 32. If each extended value stored in the valid PCR log is present in the peer PCR log, then the quoted value could comprise a valid value.

It is understood that various alternative solutions are possible for determining whether the quoted value comprises a valid value using the peer PCR log. For example, it may be specified that no additional events occur on peer device 22, that one or more of the events occur without an intervening event, that one or more specific events not have occured, that one or more events can occur in any order, etc. In any case, use of the peer PCR log and the valid PCR log enables fewer validation entries 32 to be used to store valid values for each PCR. It is also understood that while FIG. 2 shows the comparison of the quoted value and valid value as occuring on attestation server 24, similar data can be used when the comparison is performed by validation system 44. In this case, attestation server 24 can provide one or more validation entries 32 to computing device 12 for use in comparing a quoted value with a valid value.

While the discussion is generally limited to interactions between a single computing device 12 and a single attestation server 24, it is understood that each computing device 12 could have a plurality of attestation servers 24 that it trusts to verify attributes. To this extent, each attestation server 24 could be serially queried when attempting to verify a quoted value, or multiple attestation servers 24 could be concurrently queried and the corresponding results compared. Based on the results, computing device 12 can determine whether to trust peer device 22 or not. Similarly, it is understood that a plurality of certification authorities 26 may exist that generate and/or provide valid values for use in verifying attributes.

The current invention can be implemented over a public network 30 (FIG. 1) such as the Internet or an intra net for a company. In the latter case, the certification authority 26 could comprise a system manager of the company that has set up various computing devices 12 in the company in a particular manner (e.g., operating system, software configuration, BIOS, etc.). When multiple computing devices 12 seek to communicate, they can first verify the configurations in order to help prevent the spread of a virus or the like over the company's intra net.

Still yet, it should be appreciated that the teachings of the present invention could be offered as a business method on a subscription or fee basis. For example, attestation server 24 could be created, maintained and/or deployed by a service provider that offers the functions described herein for customers. That is, a service provider could offer to verify attributes for a customer as described above. It is understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of verifying an attribute of a computing device, the method comprising:
receiving a quoted value that defines the attribute from the computing device;
obtaining a valid value from an attestation server, wherein the valid value has been verified by a certification authority; and
comparing the quoted value to the valid value.

2. The method of claim 1, further comprising:
receiving an attestation identity key (AIK) from the computing device; and
verifying an accuracy of the quoted value using the AIK.

3. The method of claim 1, further comprising receiving a validation entry from the attestation server, wherein the validation entry includes the valid value and a location for a source certification authority.

4. The method of claim 1, further comprising querying the attestation server for the valid value based on the quoted value.

5. The method of claim 1, wherein the obtaining step comprises periodically receiving a set of valid values from the attestation server.

6. The method of claim 1, wherein the quoted value comprises a PCR value and a peer PCR log, and wherein the comparing step comprises comparing a valid PCR log with the peer PCR log.

7. A method of verifying an attribute of a first computing device, the method comprising:
obtaining a valid value that has been verified by a certification authority;
receiving a quoted value that defines the attribute from a second computing device; and
comparing the quoted value to the valid value.

8. The method of claim 7, wherein the obtaining step comprises periodically receiving a set of valid values from at least one of the certification authority and an attestation server.

9. The method of claim 7, further comprising providing the second computing device with a result of the comparing step.

10. The method of claim 7, further comprising storing the valid value in a validation entry that includes a location of the certification authority.

11. The method of claim 10, further comprising providing the second computing device with the location of the certification authority.

12. The method of claim 7, further comprising:
receiving an attestation identity key (AIK) and the quoted value from the first computing device at the second computing device; and
verifying an accuracy of the quoted value using the AIK.

13. The method of claim 7, wherein the quoted value comprises a PCR value and a peer PCR log, and wherein the comparing step comprises comparing a valid PCR log with the peer PCR log.

14. A system for verifying an attribute of a computing device, the system comprising:
an attestation server for storing a set of valid values, wherein each valid value has been certified by a certification authority;
an assurance system for receiving an attestation identity key (AIK) and a quoted value from the computing device and verifying the quoted value using the AIK; and
a validation system for validating the quoted value using the attestation server.

15. The system of claim 14, wherein the validation system obtains a valid value from the attestation server based on the quoted value.

16. The system of claim 14, wherein the validation system provides the quoted value to the attestation server for validation.

17. The system of claim 14, wherein the attestation server periodically receives a set of new valid values from at least one of another attestation server and the certification authority.

18. A program product stored on a recordable medium for verifying an attribute of a computing device, which when executed comprises:
program code for receiving a quoted value that defines the attribute from the computing device;
program code for obtaining a valid value from an attestation server, wherein the valid value has been verified by a certification authority; and
program code for comparing the quoted value to the valid value.

19. The program product of claim 18, further comprising:
program code for receiving an attestation identity key (AIK) from the computing device; and
program code for verifying an accuracy of the quoted value using the AIK.

20. The program product of claim 18, wherein the program code for obtaining includes:
program code for periodically receiving a set of validation entries from the attestation server; and
program code for verifying an accuracy of the set of validation entries, wherein each validation entry includes a valid value for an attribute.

21. The program product of claim 18, further comprising program code for querying the attestation server for the valid value based on the quoted value.

22. A system for deploying an application for verifying an attribute of a first computing device, the system comprising a computer infrastructure being operable to:
obtain a valid value that has been verified by a certification authority;
receive a quoted value that defines the attribute from a second computing device;
compare the quoted value to the valid value; and
provide a result of the comparison to the second computing device.

23. Computer software embodied in a propagated signal for verifying an attribute of a computing device, the computer software comprising instructions to cause a computer system to perform the following functions:
receive an attestation identity key (AIK) and a quoted value from the computing device;
verify the quoted value using the AIK; and
validate the quoted value using an attestation server that comprises a set of valid values, wherein each valid value has been certified by a certification authority.
